(19) United States
(12) Patent Application Publication
(10) Pub. No.: US 2012/0162485 A1
(43) Pub. Date: Jun. 28, 2012

(54) IMAGE PROCESSING APAPRATUS, IMAGE PROCESSING METHOD, AND PROGRAM, AND IMAGE PROCESSING SYSTEM

(75) Inventor: Takashi Okada, Saitama-shi (JP)

(73) Assignee: CANON KABUSHIKI KAISHA, Tokyo (JP)

(21) Appl. No.: 13/330,284

(22) Filed: Dec. 19, 2011

(30) Foreign Application Priority Data
Dec. 22, 2010 (JP) 2010-286524
Sep. 15, 2011 (JP) 2011-201820

(51) Int. Cl. H04N 5/217

(52) U.S. Cl. 348/241; 348/E05.078

(57) ABSTRACT

An image processing apparatus including an image restoration unit configured to acquire classification information indicating classifying variations in optical performance of an image pickup apparatus which picks up image data into a plurality of patterns, and generate restored image data by using a restoration filter generated based on the classification information is provided.

### BACKGROUND OF THE INVENTION

1. Field of the Invention

The present invention relates to an image processing apparatus, an image processing method, a program, and an image processing system that allow correcting captured image data through image-restoration processing.

2. Description of the Related Art

As the digitization of information has become pervasive, various methods of correcting captured image data have been proposed, because image data can be handled as signal values. When the image data of an object is captured with a digital camera, the captured image data is degraded due to the aberration of an optical system of the camera. The method of correcting image data, which is blurred by the aberration of an optical system, through digital processing based on the information about an optical transfer function (OTF) has hitherto been available. The above-described correction method is referred to as image recovery or image restoration. Hereinafter, the processing performed to correct the degradation of image data based on information about the OTF of the image-pickup optical system will be referred to as restoration processing.

At an actual manufacturing field, variations occur in the performance of an optical system due to errors occurring during the lens manufacturing, errors occurring during the manufacturing of a lens barrel holding a lens, etc. Hitherto, part of the optical system or an image pickup device was adjusted and caused to be eccentric to reduce the effects of the manufacturing variations. However, the eccentricity adjustment does not allow reducing the effects of the manufacturing variations. Therefore, there is a difference between the aberration characteristic obtained in the actual shooting state and that likely to be obtained in the case where the restoration processing is performed. Further, ringing or the like often occurs in the restored image data as an artifact. Thus, the manufacturing variations often exert harmful effects on the restored image data.

Accordingly, U.S. Patent Application Publication No. 2007/0081224 discloses the method of incorporating the restoration processing into the evaluation reference provided to make an adjustment to the optical system of an image pickup apparatus to adjust the optical system considering the total performance including the restoration processing. Further, US 2008/0080019 discloses the method of storing information about a plurality of restoration filters in a storage unit in advance, the restoration filters causing restored image data to satisfy a specified evaluation value.

However, according to the method disclosed in US 2007/0081224, the restoration processing enhances a performance variation which eventually remains after the manufacturing variation occurs in the image pickup apparatus, which makes it difficult to output high-quality image data with stability. For solving the above-described problem, parameters that are given at the restoration filter generation time should be changed, and the balance between the restoration degree and the performance variation should be adjusted while reducing the restoration degree.

A restoration filter used in the image pickup apparatus is determined based on at least one of parameters including the image height, the focal length, the object distance, the f number (Fno), and the vibration isolation state of the image pickup apparatus. Therefore, according to the method disclosed in U.S. Patent Application Publication No. 2008/0080019, a huge memory capacity is consumed to store information about restoration filters including the manufacturing variation in the storage unit.

### SUMMARY OF THE INVENTION

Accordingly, the present invention provides an image processing apparatus, an image processing method, a program, and an image processing system that can output high-quality image data with stability through restoration processing even though a performance variation is caused by the manufacturing. The present invention further provides an image processing apparatus, an image processing method, a program, and an image processing system that can reduce the memory capacity of a filter.

For solving the above-described problems, an image processing apparatus according to an aspect of the present invention includes an image restoration unit configured to acquire classification information indicating classifying variations in optical performance of an image pickup apparatus which picks up image data into a plurality of patterns, and generate restored image data by using a restoration filter generated based on the classification information.

Further, an image processing method according to another aspect of the present invention includes acquiring classification information indicating classifying variations in optical performance of an image pickup apparatus which picks up image data into a plurality of patterns, and generating restored image data by using a restoration filter generated based on the classification information.

Further, a program according to another aspect of the present invention causes an information processing apparatus to execute the steps of acquiring classification information indicating classifying variations in optical performance of an image pickup apparatus which picks up image data into a plurality of patterns, and generating restored image data by using a restoration filter generated based on the classification information.

Further, an image processing system including the image processing apparatus constitutes another aspect of the present invention.

Further features of the present invention will become apparent from the following description of exemplary embodiments with reference to the attached drawings.

### BRIEF DESCRIPTION OF THE DRAWINGS

FIG. 1 illustrates an image processing system according to a first embodiment of the present invention.

FIG. 2 is a flowchart illustrating the first embodiment.

FIG. 3 illustrates a restoration filter according to an embodiment of the present invention.

FIG. 4 is a section view of a restoration filter according to another embodiment of the present invention.

FIG. 5 illustrates restored image data according to another embodiment of the present invention.

FIG. 6 illustrates a restoration filter selection method performed according to another embodiment of the present invention.

FIG. 7A illustrates manufacturing variations.

FIG. 7B illustrates manufacturing variations spread by restoration.

FIG. 7C illustrates manufacturing variations by restoration according to one embodiment of the present invention.

FIG. 8 illustrates an image processing system according to a second embodiment of the present invention.

FIG. 9 illustrates an image processing system according to a third embodiment of the present invention.

FIG. 10 illustrates an image processing system according to a fourth embodiment of the present invention.

FIG. 11 illustrates an image processing system according to a fifth embodiment of the present invention.

FIG. 12 illustrates an image processing system according to a sixth embodiment of the present invention.

FIG. 13 illustrates an image processing system according to a seventh embodiment of the present invention.

FIG. 14 illustrates an image processing system according to an eighth embodiment of the present invention.

### DESCRIPTION OF THE EMBODIMENTS

Hereinafter, embodiments of the present invention will be described in detail with reference to the attached drawings. According to an embodiment of the present invention, an image processing apparatus, an image processing method, a program, and an image processing system that allow processing performed to output high-quality image data with stability irrespective of a performance variation caused by the manufacturing and that allow reducing the memory capacity are provided.

### First Embodiment

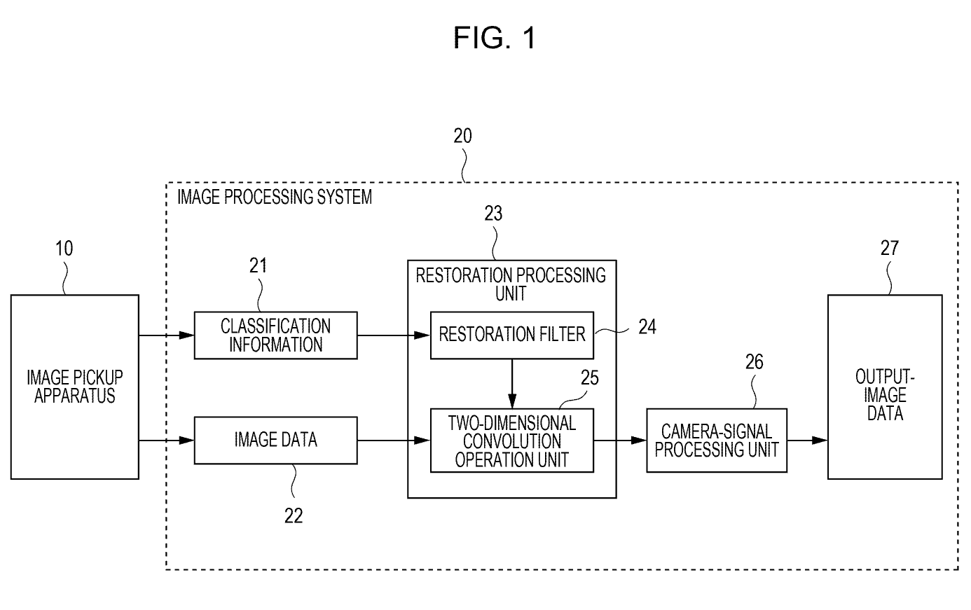

FIG. 1 is a block diagram illustrating the configuration of an image processing system including an image processing apparatus according to a first embodiment of the present invention. According to a known method, the restoration processing enhances a performance variation that eventually remains after the manufacturing variation occurs in an image pickup apparatus, which makes it difficult to output high-quality image data with stability. For solving the above-described problem, a huge filter capacity is consumed and the cost of manufacturing a filter is significantly increased. An advantage of the present invention is to provide the method of achieving high-quality image data and reducing the memory capacity by performing the restoration processing through the use of a restoration filter specified based on the information of classified performance variations occurring due to the manufacturing variation of an image pickup apparatus that picks up image data. Further, the manufacturing cost is reduced as another advantage of the present invention.

In the first embodiment, information 21 about classified performance variations occurring due to the manufacturing variation of an image pickup apparatus 10 and image data 22 provided as RAW data are transmitted from the image pickup apparatus 10 to an image processing system 20 when the image pickup apparatus 10 is connected to the image processing system 20. The classification information 21 is provided to specify a restoration filter 24 or an optical transfer function. More specifically, the classification information 21 includes information about the identification numbers of the restoration filters, the identification numbers of optical transfer functions, and the identification numbers of image pickup apparatuses, for example.

In the image processing system 20, a restoration processing unit 23 specifies the restoration filter 24 based on the classification information 21. In a two-dimensional convolution operation unit 25, a two-dimensional convolution operation is performed based on the restoration filter 24 and the image data 22 to perform the restoration processing. A camera-signal processing unit 26 performs camera-signal processing including demosaicing processing, white-balance adjustment, edge enhancement, noise-reduction processing, and so forth for restored image data, and output-image data 27 is output. Here, the camera-signal processing may be performed after the two-dimensional convolution operation, or part of the camera-signal processing may be performed before the two-dimensional convolution operation. The image processing system 20 displays the restored output image data 27 on a display unit (not shown).

A storage unit (not shown) of the image processing system 20 stores information about the restoration filter or optical transfer function corresponding to the classification information of a performance variation which is classified in advance. For example, an eccentric coma aberration may be given as a single pattern of aberrations caused by the manufacturing variations. The storage unit stores information about a restoration filter or an optical transfer function arranged to restore the eccentric coma aberration.

Thus, the restoration processing is performed based on the restoration filter corresponding to the aberration pattern to provide high-quality restored image data. Further, since information about the restoration filter corresponding to the pattern of an aberration occurring due to the manufacturing variation is stored in the storage unit in advance, the memory capacity may be reduced as appropriate.

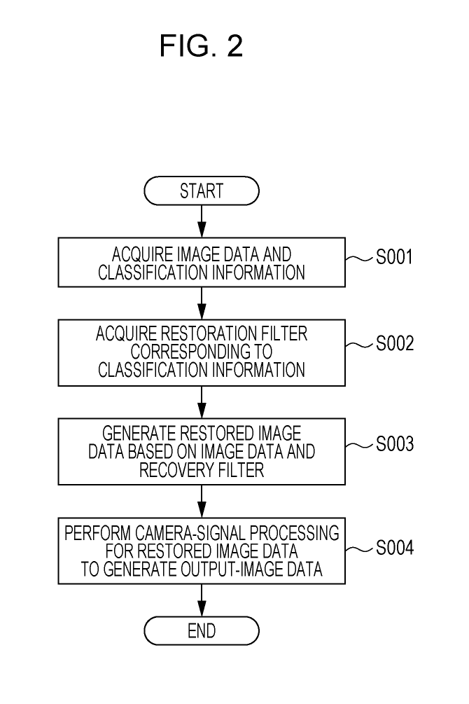

FIG. 2 shows a flowchart illustrating the above-described processing procedures. First, at step S001, the image pickup apparatus 10 transmits the image data 22 including the classification information 21 to the image processing system 20. In other words, the image processing system 20 acquires the image data 22 and the classification information 21 from the image pickup apparatus 10. At step S002, the image processing system 20 acquires the restoration filter 24 corresponding to the classification information 21 from the storage unit. At step S003, the image processing system 20 performs the two-dimensional convolution operation based on the image data 22 and the restoration filter 24 to generate restored image data. At step S004, the image processing system 20 performs the camera-signal processing for the restored image data to generate the output-image data 27.

The processing procedures of the above-described steps are performed by a control unit controlling the image processing system 20 including an image-processing integrated circuit (IC), an interface, and so forth based on instructions from a program. Further, when an embodiment of the present invention is performed through a program, the program may include the step of storing classification information indicating aberrations that are classified into several patterns, where the aberrations appear on image data due to the manufacturing errors, in the image processing system (e.g., an information processing apparatus).

According to the above-described method, the classification information and the image data are separately transmitted. Since the classification information is unique to the image pickup apparatus 10, the classification information may be stored in the image processing system 20 at the time when the image pickup apparatus 10 is purchased to perform image processing based on the classification information and image data acquired through normal shooting. Consequently, the classification information is not exchanged between the image pickup apparatus 10 and the image processing system 20 every time shooting is performed, which increases the efficiency of the image processing system 20.

The restoration filter 24 used in the first embodiment is generated through the use of information about the optical transfer function based on classification indicated by the classification information 21, the classification being performed during the variation adjustment which will be described later.

A restoration filter according to an embodiment of the present invention is generated based on the optical transfer function of an image pickup system. The optical transfer function may include a factor degrading not only the image-pickup optical system of an image pickup apparatus, but also the optical transfer function during imaging. For example, an optical low-pass filter having double refraction reduces a high-frequency component in response to the frequency characteristic of the optical transfer function. In addition, there are the opening shape or the spectral characteristic of a photo detector of the light source, and the spectral characteristics of various wavelength filters. The restoration processing may be performed based on a broadly defined optical transfer function including the above-described factors. Hereinafter, in this specification, each of a single image-pickup optical system, and a system including the image-pickup optical system and a photo detector or a filter is referred to as the image pickup system.

An image processing method according to an embodiment of the present invention can be applied to image generation apparatuses having no image-pickup optical system, such as a scanner (reader) and an X-ray image pickup apparatus performing imaging while an image pickup element is brought into contact with the object surface. Although no image-pickup optical system including lenses, etc. is provided in those apparatuses, the quality of image data output therefrom is degraded because of, for example, image sampling performed with the image pickup element. Although not caused by the image-pickup optical system, the above-described degradation characteristic is the transfer function of a system, and therefore corresponds to the above-described optical transfer function. Accordingly, restored image data can be generated without having the image-pickup optical system by generating a restoration filter based on the transfer function of the system, the transfer function corresponding to the optical transfer function. In this specification, the optical transfer function includes the transfer function of the system.

In an actual image pickup apparatus, a variation occurs in the optical transfer function due to the curvature, the distance between lens surfaces, the refractive index, and the eccentricity of a lens, the eccentricity of a lens unit or that of a photo detector, etc., which are caused by the manufacturing error. In this specification, a variation occurring in the optical transfer function of each image pickup apparatus, which is caused by the manufacturing error, is referred to as a variation in the optical performance. Usually, an optical adjustment is made to an image-pickup optical system to reduce the degradation characteristic thereof, which is caused by the manufacturing variation, by causing a lens (optical element) or an adjustment unit holding the lens to be eccentric toward a direction perpendicular to the optical axis of an optical system.

Returning to FIG. 1, the first embodiment will be described again. To image data generated with imaging performed by the image pickup apparatus 10, information about the imaging conditions including the focal length, the aperture, the imaging distance, etc. of the image-pickup optical system and various types of correction information provided to correct the image data may be attached.

The classification information 21 includes information provided to specify a restoration filter, such as information about the identification number of the restoration filter 24. Further, the classification information 21 may include information specifying an optical transfer function that can generate a restoration filter through Fourier transformation. In that case, information about an optical transfer characteristic that allows correcting an aberration occurring due to the manufacturing variation is stored in a storage unit provided on the image-processing system side.

The image processing system 20 may acquire the image data 22 and the classification information 21 from the image pickup apparatus 10 via a cable, or by radio. Otherwise, the image processing system 20 may receive data transmitted from a recording medium such as a memory card storing the image data 22 or the classification information 21.

Hereinafter, restoring processing performed in the image processing system 20 according to an embodiment of the present invention will be schematically described. When degraded image data, original image data, and a point spread function (PSF) which is paired with an optical transfer function to achieve a Fourier pair are determined to be g(x, y), f(x, y), and h(x, y), respectively, the following equation holds, where the sign * indicates a two-dimensional convolution operation (convolution integration), and the points (x, y) indicates coordinates that are shown on image data.

g(x, y)=h(x, y)*f(x, y) (1)

When Equation (1) is subjected to Fourier transformation and transformed into data to be displayed on the frequency plane, the data is expressed as the product of frequencies, as shown in Equation (2) described below. The sign H denotes an optical transfer function obtained by performing Fourier transformation for a function h, and the signs G and F denote optical transfer functions that are obtained by performing Fourier transformation for functions g and f, respectively. The points (u, v) denote coordinates shown on the two-dimensional frequency plane, that is, a frequency.

G(u, v)=H(u, v)·F(u, v) (2)

To obtain the original image data f(x, y) from the degraded image data g(x, y) captured through imaging, each side of the equation (2) is divided by H as below.

G(u, v)/H(u, v)=F(u, v) (3)

The F(u, v), that is, G(u, v)/H(u, v) is subjected to inverse Fourier transformation and returned to a real plane (real space) so that the original image data f(x, y) is obtained as restored image data. Here, when determining the result of performing inverse Fourier transformation for 1/H to be R and performing the two-dimensional convolution operation for the image data shown on the real plane, the original image data can also be obtained as shown in Equation (4):

g(x, y)*R(x, y)=f(x, y) (4).

The sign R(x, y) denotes the restoration filter. When two-dimensional image data is provided, the restoration filter usually becomes a two-dimensional filter including the taps (cells) corresponding to the pixels of the two-dimensional image data. Here, the restoration precision is usually increased with an increase in the number of the taps (the number of the cells) of the restoration filter. Therefore, the number of the taps is increased to a realizable number based on the demanded image quality, the image processing capacity, the aberration characteristic, and so forth.

A filter provided to achieve the above-described restoration should reflect the aberration characteristic. Accordingly, the filter has a technical property different from that of a known edge-enhancement filter (high-pass filter) which does not reflect the aberration characteristic and includes approx. three horizontal taps and approx. three vertical taps.

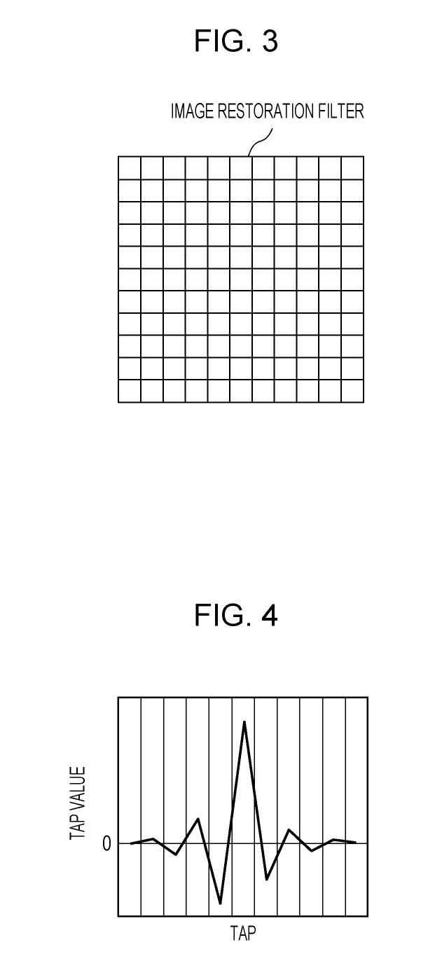

FIG. 3 illustrates a two-dimensional filter including 11×11 taps, as an exemplary restoration filter. The taps of the restoration filter correspond to the respective pixels of image data. The two-dimensional convolution operation is known as processing performed to cause a given pixel to agree with the center of a restoration filter to improve the signal value of the given pixel, calculate the product of the signal value of the given pixel and the coefficient value of the restoration filter of each of the corresponding taps, and replace the sum total of the products with the signal value of the center pixel.

Although the value of each tap is not illustrated in FIG. 3, a section view of the above-described restoration filter is illustrated in FIG. 4. The distribution of values (coefficient values) of the taps of the restoration filter returns signal values that are spatially expanded due to an aberration, ideally, to the original single point. The restoration filter may be obtained by calculating or measuring the optical transfer function of the image-pickup optical system and performing inverse Fourier transformation for a function calculated based on the inverse function of the optical transfer function.

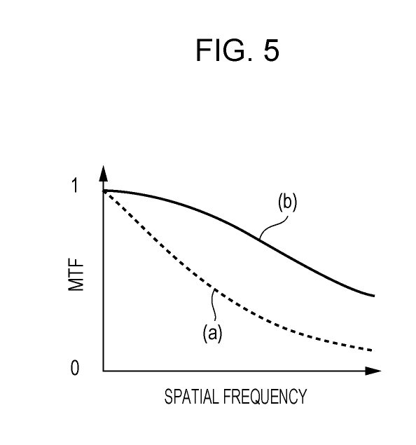

Since actual image data includes noise components, the use of the restoration filter which is generated based on the reciprocal of the optical transfer function, as stated above, restores degraded image data, and amplifies the noise components. Therefore, it is usually difficult to obtain appropriate image data. As one of the methods of solving the above-described problem, the method of controlling the restoration degree based on the intensity ratio between image data and a noise signal (signal to noise ratio (SNR)), which is illustrated in FIG. 5, has been available. A restoration filter appropriately used for the above-described method is referred to as the Wiener filter.

The restoration filter reduces amplification with a decrease in the absolute value of the optical transfer function (modulation transfer function (MTF)) for each frequency and increases the degree of amplification with an increase in the absolute value of the optical transfer function (MTF). Usually, the absolute value of the optical transfer function (MTF) of an image-pickup optical system is decreased on the high-frequency side as indicated by a curve (a) illustrated in the graph of FIG. 5. Accordingly, the Wiener filter reduces the degree of high frequency-side restoration of image data as indicated by a curve (b) illustrated in the graph of FIG. 5.

An appropriate restoration filter should be selected in accordance with conditions obtained at the time when image data is captured. In the image processing system 20, information about a plurality of restoration filters or optical transfer functions appropriate for the imaging conditions is stored in the storage unit (not shown in FIG. 1).

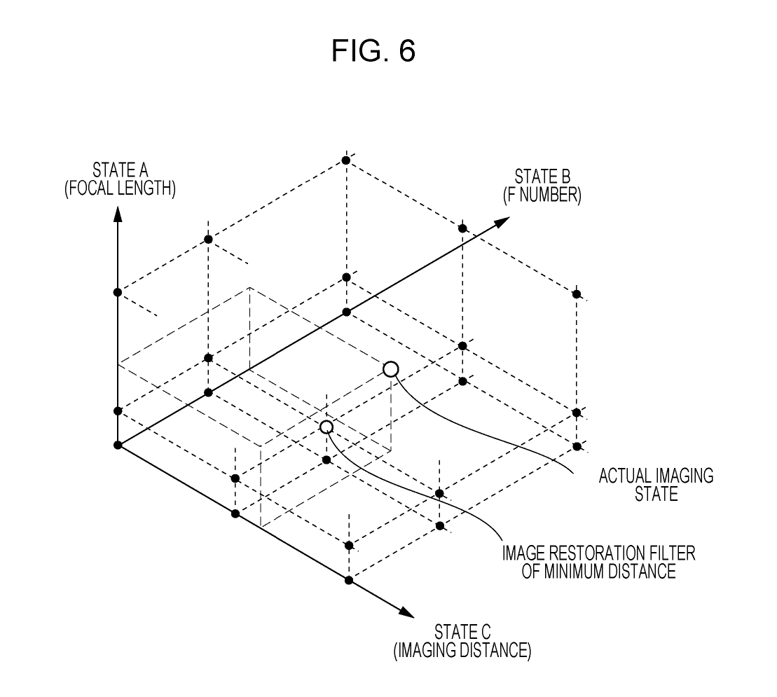

FIG. 6 schematically illustrates a group of restoration filters, of which information being stored in the storage unit. In the storage unit, information about restoration filters that are discretely arranged in space defined with a focal length, an f number (Fno), and an imaging distance as its axes is stored. In other words, information about a restoration filter that can restore image data captured under the imaging conditions corresponding to the coordinates of each of points (black circles) shown in the space with precision is stored in the storage unit. The restoration filter, of which information being stored in the storage unit, is not limited to those corresponding to grid points orthogonal to the imaging conditions as indicated by the black circles illustrated in FIG. 6. That is, information about the restoration filter corresponding to a point deviated from the grid point may be stored in the storage unit. Further, even though a three-dimensional drawing is generated based on the three conditions that are provided as the imaging-condition parameters for illustration, at least four-dimensional space may be provided for at least four imaging-condition parameters.

Methods of selecting a restoration filter will be described. When an imaging condition indicated by a large white circle shown in FIG. 6 is the imaging condition of image data and information about the restoration filter corresponding to a point which is significantly close to the imaging condition is stored, the restoration filter may be selected to perform the restoration processing. When the information about the restoration filter corresponding to the close point is not stored, the distances between actual imaging conditions and the stored imaging conditions, which are caused in the space, are calculated, and the shortest distance of all is selected, which constitutes another restoration filter selection method. In FIG. 6, a restoration filter provided at the position indicated by a small white circle is selected, for example. According to another method, weights may be assigned to the restoration filters for selection based on their directions in the space. That is, the product of a distance caused in the space and a weight-assignment coefficient may be selected as an evaluation function, which also constitutes another restoration filter selection method.

Next, the camera-signal processing performed with the camera-signal processing unit 26 will be described. The camera-signal processing is image processing including the demosaicing processing, the white-balance adjustment, the edge enhancement, the noise-reduction processing, and so forth, which is performed for the RAW image data. Otherwise, when the image processing is performed based on the optical transfer function, the camera-signal processing includes a distortion-aberration correction, a lateral-chromatic-aberration correction, a shading correction, etc. that are performed to make a geometric aberration correction without using any restoration filters. The above-described camera-signal processing procedures may be inserted before and after the two-dimensional convolution operation as appropriate.

Here, for performing the restoration processing, input image data may not be subjected to various types of applicable non-linear processing, because as the linearity of the process of degrading the image data grows, so does the precision with which the degradation processing is performed the other way round so that the degraded image data is restored to original image data provided before the degradation. Accordingly, the restoration processing may be performed for the RAW image data. However, when image data subjected to the camera-signal processing is linearly degraded due to color-interpolation processing, the image data can be restored with precision by considering the degradation function during the restoration filter generation. Further, when the restoration-request precision is low or when image data subjected to various types of image processing is selected, the restoration processing may be performed for image data subjected to the camera-signal processing or image data subjected to image-compression processing.

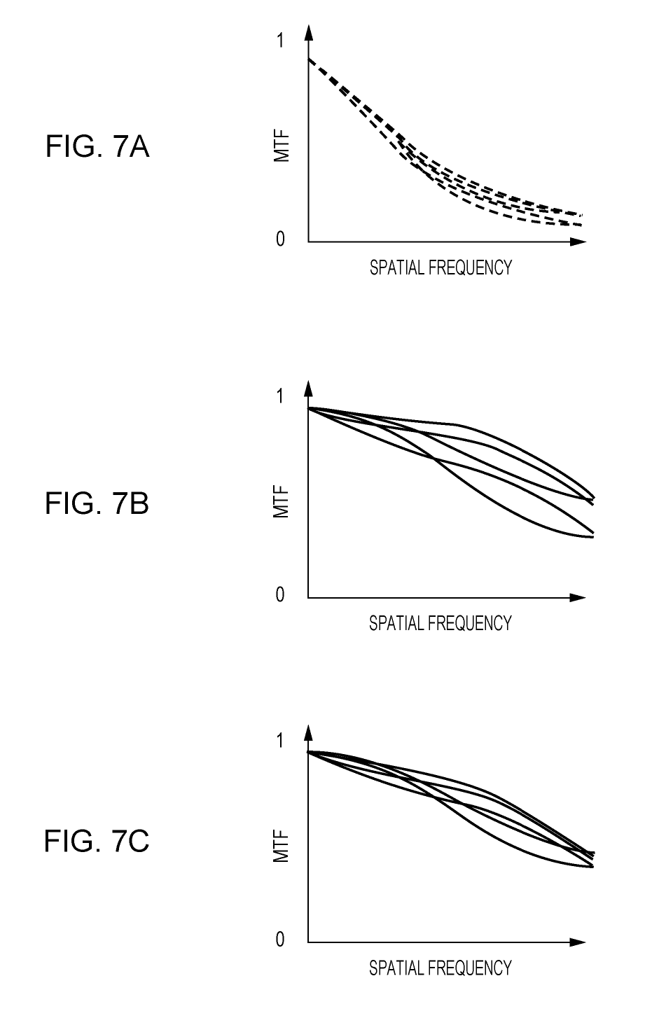

Next, the adjustment to the manufacturing variation occurring during the process of manufacturing the image pickup apparatus 10 will be described. At the same time as when the manufacturing variation occurs, a variation occurs in the optical transfer function of the image pickup apparatus 10 due to the manufacturing variation. When the restoration processing is performed for an image pickup system where a manufacturing variation occurs with a certain degree of restoration based on an optical transfer function specified based on, for example, a design value, the performance variation of the image pickup apparatus is also amplified in accordance with the restoration degree. FIG. 7A illustrates manufacturing variations occurring in an image pickup system. FIG. 7B illustrates a result of generating a restoration filter based on an optical transfer function calculated based on a design value and performing the restoration processing for the image pickup system.

The restoration filter used in the case of FIGS. 7A to 7C is the Wiener filter. However, since the degree of high-frequency restoration of the MTF is reduced, the degree of intermediate-frequency restoration is most significant and performance variations observed in the corresponding part are increased. Further, since the restoration filter is obtained by performing Fourier transformation for the reciprocal of the optical transfer function, the restoration degree of the restoration filter is increased when the image-forming capability of the image pickup system is low, that is, when the MTF has a low value. In the above-described image pickup apparatus, the performance variation occurring due to the manufacturing variation is increased.

For solving the above-described problem, the method of making an adjustment appropriate for the restoration filter while evaluating performance attained after the restoration processing may be considered. However, since the restoration filter is specified, the above-described method does not allow a radical solution to the performance variation. For attaining the radical solution to the performance variation, the method of individually measuring the optical transfer functions of manufactured image pickup apparatuses and generating restoration filters appropriate for the respective image pickup apparatuses may be considered. However, the construction of a new manufacturing line and an increase in the manufacturing cost are expected to achieve the method, which is not practical.

Accordingly, an embodiment of the present invention allows attaining the radical solution to the performance variation through the use of a plurality of patterned restoration filters as illustrated in FIG. 7C. With regard to known performance variations remaining after adjustments that are made at the manufacturing time, a rotationally asymmetric aberration which causes different performances at four corners of image data and an asymmetric aberration occurring at the center of image data are significant. Thus, the degradation characteristics remaining after the adjustments are classified as three to ten patterns of aberration. Accordingly, an embodiment of the present invention allows reducing the amplification of the manufacturing variation and retarding an increase in the manufacturing cost through the use of several types of restoration filters. At that time, the restoration filters are used to correct the above-described aberration which is asymmetrical about the center of the image data. Therefore, at least one of the restoration filters of several types may be a filter which is asymmetrical about the center of the image data.

As a specific adjustment method, an evaluation unit, a classification unit, a restoration unit, and an adjustment unit, which will be described later, are operated. Without being limited to the above-described order, those units may be operated in any order as appropriate.

The evaluation unit is provided to evaluate the degree of degradation of the performance of the image pickup system during the adjustment. There is a method of evaluating an optical system by providing a chart with which the image-forming capability of the optical system is evaluated on the photo detector-side of an image pickup apparatus, applying light from the photo detector-side, and arranging a sensor at the position of the object body. Further, there is a method of evaluating the performance of an image pickup system by providing the chart on the subject side and capturing the image data of the chart by arranging a sensor at the actual position of a photo detector as is the case with normal shooting.

For either of the evaluations, the sensor for use may be selected in accordance with the evaluation. Namely, a line sensor may be provided to evaluate a section of the image-forming capability, and a two-dimensional sensor may be provided to evaluate every azimuth direction as is the case with actual shooting. Further, the image-forming capability for evaluation may be the image-forming capability of an image pickup system where the manufacturing error occurs, or image data restored with the restoration unit may be evaluated. Still further, image data items that are adjusted with the adjustment unit may be successively evaluated, without being limited to the above-described methods.

The classification unit is provided to classify the degree of degradation of the performance of the optical system of the image pickup system during the adjustment. As stated above, the degradation characteristic of the image pickup apparatus may be eventually classified into several patterns (several types). The classification unit determines which pattern of degradation characteristic is closest to the performance degradation caused by the optical system, and performs classification in accordance with a restoration filter for use. For example, at the occurrence of the rotationally asymmetric aberration causing different performances at the four corners of image data, the classification reference may be obtained by comparing the maximum value and the minimum value of the size of an image-forming spot of each of the four corners. The classification unit may perform classification based on the image-forming capability evaluated with the evaluation unit or image data adjusted with the adjustment unit. However, the classification unit may perform classification without being limited to the above-described embodiment. Information about the restoration filter classification, which is eventually output from the image pickup apparatus, may be updated based on classification performed with the classification unit. As a consequence, it becomes possible to decrease the number of filters held in the image pickup apparatus and the image processing system so that the memory of the image pickup apparatus is used with efficiency.

The restoration unit is provided to restore the performance of the image pickup system of the image pickup apparatus during the adjustment. The chart image obtained with the image pickup system is detected with the sensor of an adjuster and converted into electric signals. The electric signals are determined to be input signals to perform the same image processing as that of the above-described restoration processing. For example, a restoration filter provided for the image pickup apparatus may be used to detect a chart provided on the object-body side with a sensor arranged on the face of a photo detector.

Further, when detecting a chart on the object-body plane, the chart being provided on the photo-detector side, the restoration processing may be performed by generating an adjustment restoration filter based on the restoration filter used for the image pickup apparatus. Further, a restoration filter used for the restoration unit is obtained by averaging the optical transfer functions of the image pickup apparatus where the manufacturing variation occurs. In that case, however, excessive restoration may be performed for a lens with higher performance than the average optical performance.

In such cases, a restoration filter may be selected based on the optical transfer function of an image pickup system having the highest capability of image-forming capabilities including the manufacturing variation. Without being limited to the above-described embodiments, any restoration filter may be used, so long as the ultimate performance thereof, which is attained after the adjustment of the manufacturing variation, achieves the highest value. The restoration unit may restore the image-forming capability of an image pickup system where the manufacturing error occurs, or restore image data evaluated with the evaluation unit without being limited to the above-described method.

The adjustment unit is provided to adjust the performance of the image pickup system of the image pickup apparatus. The adjustment unit changes an adjuster provided in the image pickup apparatus to change the optical transfer functions continuously and minutely. The adjuster is changed to cancel (reduce) a discrepancy between the value of a designed optical transfer function and that of the optical transfer function of the image pickup apparatus where the manufacturing error occurs.

The adjuster is part of the image pickup system of the image pickup apparatus, or the entire image pickup system, or the photo detector. As a specific method of changing the adjuster, a shift (eccentricity or translation) or a tilt may be given to the adjuster, or the adjuster may be moved toward the optical-axis direction in stages. According to the above-described method, a mechanical change causes a change in the optical transfer function. However, the optical transfer function may be electrically changed as is the case with a phase modulation element or a liquid crystal lens.

The adjustment unit may make an adjustment based on the image-forming capability of the image pickup system where the manufacturing error occurs or make an adjustment based on image data restored with the restoration unit (so that the restored image data obtains a desired capability).

### Second Embodiment

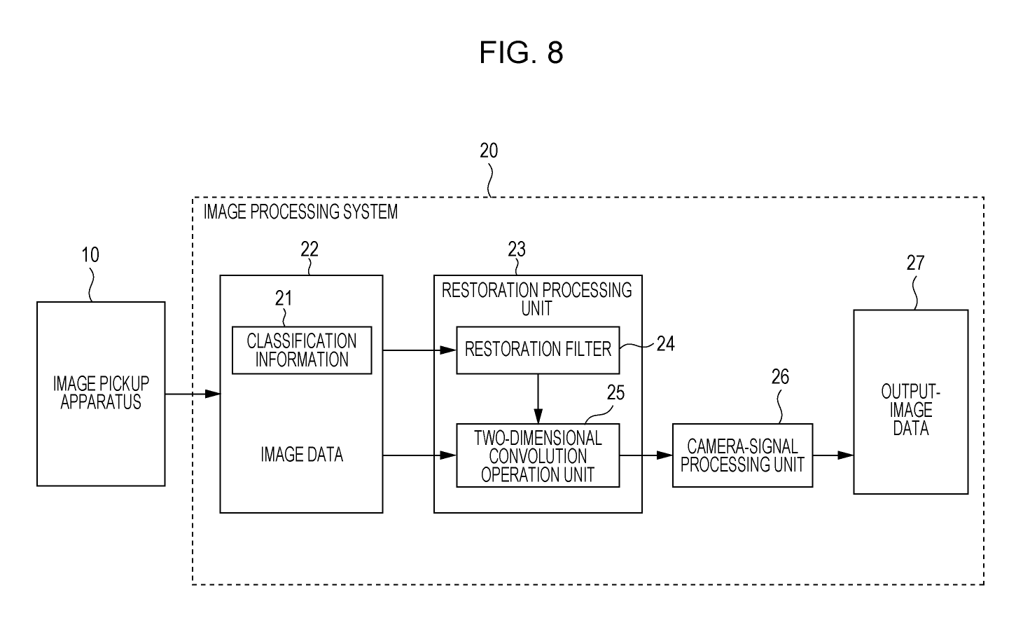

Hereinafter, an image processing system according to a second embodiment of the present invention will be described with reference to FIG. 8. The second embodiment is different from the first embodiment in that the classification information 21 is attached to the image data 22. In the second embodiment, the image data 22 provided as RAW data including the information 21 provided to classify a performance variation occurring due to the manufacturing variation in the image pickup apparatus 10 is transmitted when the image pickup apparatus 10 is connected to the image processing system 20. In the image processing system 20, the restoration processing unit 23 specifies the restoration filter 24 based on the classification information 21. In the two-dimensional convolution operation unit 25, the two-dimensional convolution operation is performed to two-dimensionally convolute the restoration filter 24 in the image data 22 to perform the restoration processing. The camera-signal processing unit 26 performs the camera-signal processing including the demosaicing processing, the white-balance adjustment, the edge enhancement, the noise-reduction processing, etc. for the restored image data, and the output-image data 27 is output.

### Third Embodiment

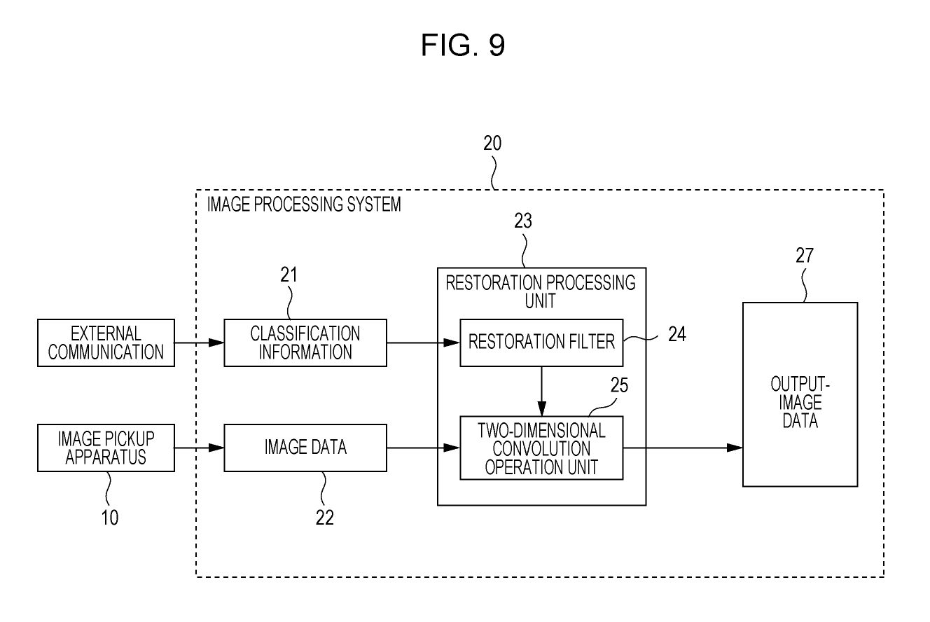

Hereinafter, the image processing system 20 according to a third embodiment of the present invention will be described with reference to FIG. 9. The third embodiment is different from the first embodiment in that the classification information 21 is transmitted from the outside. In the third embodiment, the image data 22 that had been subjected to the camera-signal processing including the demosaicing processing, the white-balance adjustment, the edge enhancement, the noise-reduction processing, etc. with an image-processing IC provided in the image pickup apparatus is transmitted when the image pickup apparatus 10 is connected to the image processing system 20.

On the other hand, the classification information 21 is acquired via the Internet independently of the image data 22 transmitted from the image pickup apparatus 10. Otherwise, the classification information 21 is transmitted to the image processing system 20 through infrared communications or communications that are performed with Bluetooth or the like, which are established between the image processing system 20 and another communication apparatus having the classification information 21. In the image processing system 20, the restoration processing unit 23 specifies the restoration filter 24, of which information being stored in the storage unit (not shown), based on the classification information 21. In the restoration processing unit 23, the two-dimensional convolution operation unit 25 performs the two-dimensional convolution operation for the restoration filter 24 and the image data 22 to perform the restoration processing, and the output-image data 27 is output.

### Fourth Embodiment

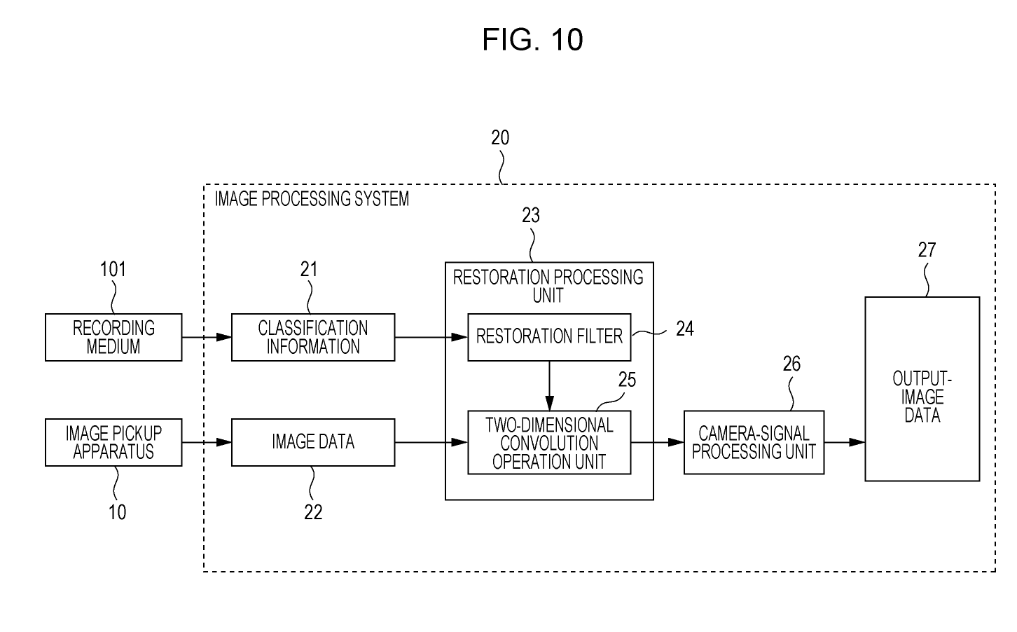

Hereinafter, an image processing system according to a fourth embodiment of the present invention will be described with reference to FIG. 10. The fourth embodiment is different from the first embodiment in that the image processing system 20 acquires the classification information 21 from a recording medium 101. In the fourth embodiment, the image data 22 provided as RAW data is transmitted when the image pickup apparatus 10 is connected to the image processing system 20.

On the other hand, the classification information 21 stored in the recording medium 101 including a USB memory or the like is transmitted to the image processing system 20. In the image processing system 20, the restoration processing unit 23 specifies the restoration filter 24 based on the classification information 21, and the restoration processing is performed by performing the two-dimensional convolution operation to two-dimensionally convolute the restoration filter 24 in the image data 22. The camera-signal processing unit 26 performs the camera-signal processing including the demosaicing processing, the white-balance adjustment, the edge enhancement, the noise-reduction processing, etc. for the restored image data, and the output-image data 27 is output.

### Fifth Embodiment

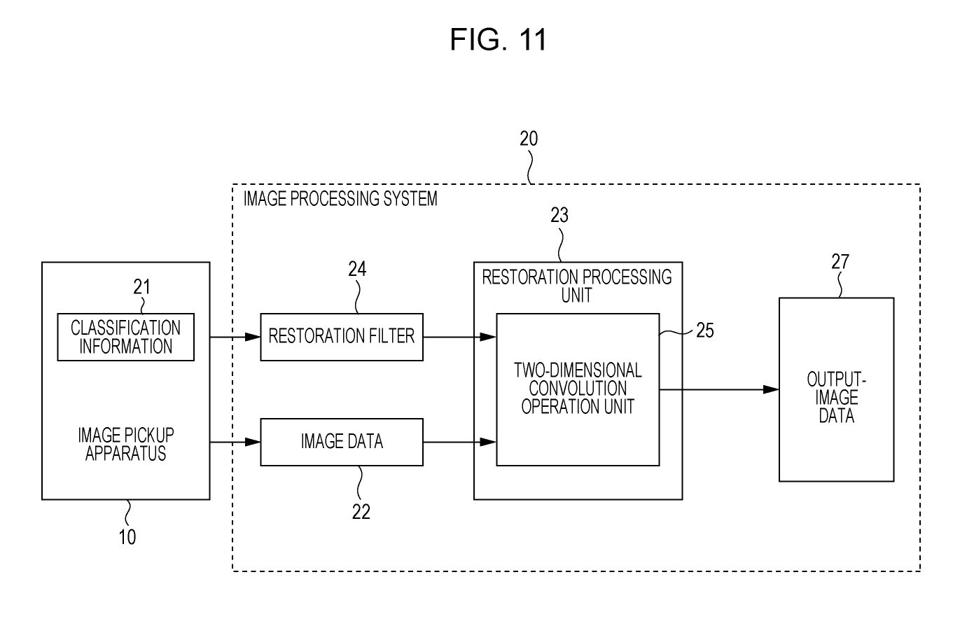

Hereinafter, an image processing system according to a fifth embodiment of the present invention will be described with reference to FIG. 11. The fifth embodiment is different from the first embodiment in that the classification information 21 is held in the image pickup apparatus 10, and the restoration filter 24 is generated in the image pickup apparatus 10. When the image pickup apparatus 10 is connected to the image processing system 20, information about the restoration filter 24 and the image data 22 subjected to the camera-signal processing including the demosaicing processing, the white-balance adjustment, the edge enhancement, the noise-reduction processing, etc. are transmitted. In the image processing system 20, the restoration processing unit 23 performs the restoration processing by performing the two-dimensional convolution operation to two-dimensionally convolute the restoration filter 24 in the image data 22, and the output-image data 27 is output.

According to the above-described method, information about the restoration filter and the image data are separately transmitted. The restoration filter specified based on the classification information is information unique to the image pickup apparatus. Therefore, it becomes possible to store the restoration filter information in the image processing system at specified time such as the time when the image pickup apparatus is purchased, and perform the image processing based on the restoration filter information and image data acquired through normal shooting.

Consequently, the restoration filter information is not exchanged between the image pickup apparatus and the image processing system every time shooting is performed, which increases the efficiency of the image processing system.

### Sixth Embodiment

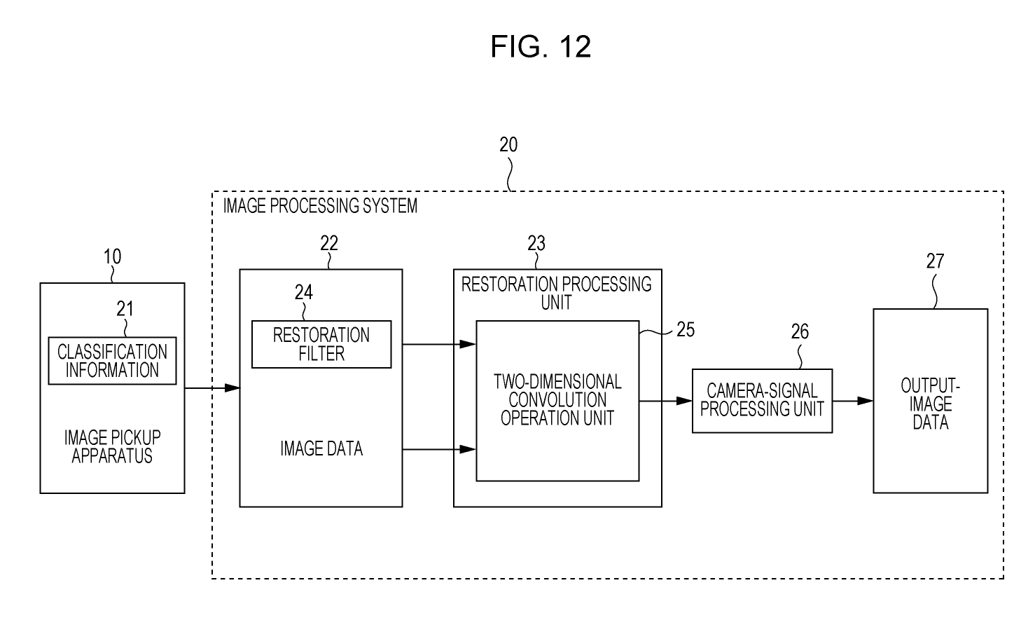

Hereinafter, an image processing system according to a sixth embodiment of the present invention will be described with reference to FIG. 12. The sixth embodiment is different from the first embodiment in that the classification information 21 is held in the image pickup apparatus 10, and the restoration filter 24 is generated in the image pickup apparatus 10. When the image pickup apparatus 10 is connected to the image processing system 20, the image data 22 provided as RAW data, which includes information about the restoration filter 24, is transmitted. In the image processing system 20, the restoration processing is performed by performing the two-dimensional convolution operation so that the restoration filter 24 is two-dimensionally convoluted in the image data 22. The restored image data is subjected to the camera-signal processing including the demosaicing processing, the white-balance adjustment, the edge enhancement, the noise-reduction processing, etc., and the output-image data 27 is output.

According to the above-described embodiment, data items to be transmitted to the image processing system are combined into a single group. Therefore, the data exchange can be easily performed. Further, the storage of the restoration filter information allows reducing operations of the image processing system, and decreasing the time consumed in relation to the image processing.

### Seventh Embodiment

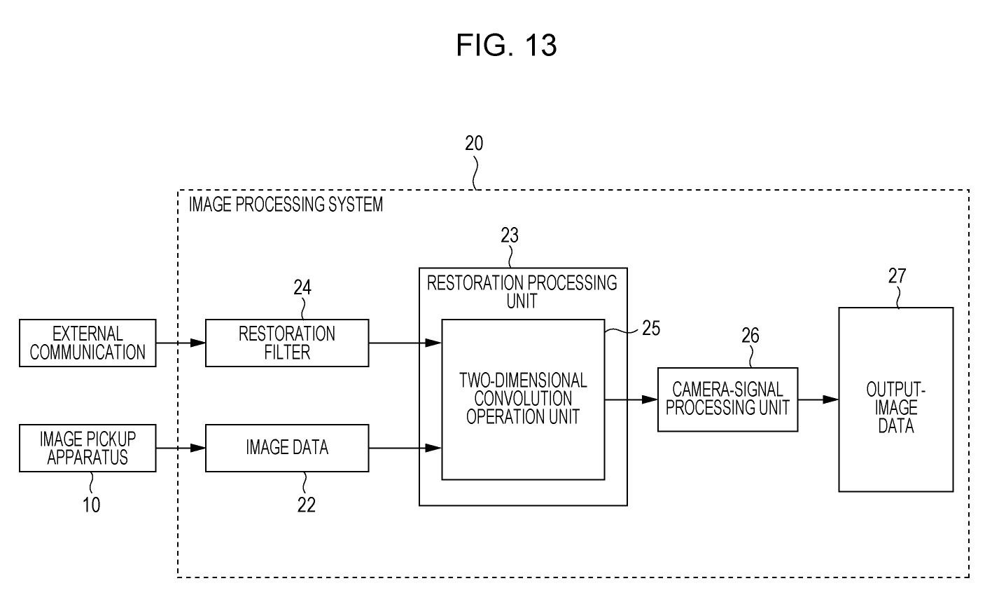

Hereinafter, an image processing system according to a seventh embodiment of the present invention will be described with reference to FIG. 13. The seventh embodiment is different from the first embodiment in that the restoration filter is acquired from the outside. The seventh embodiment allows selecting and downloading a specified restoration filter from among a plurality of restoration filters via the Internet, or acquiring another specified restoration filter through communications that are established with a different device.

### Eighth Embodiment

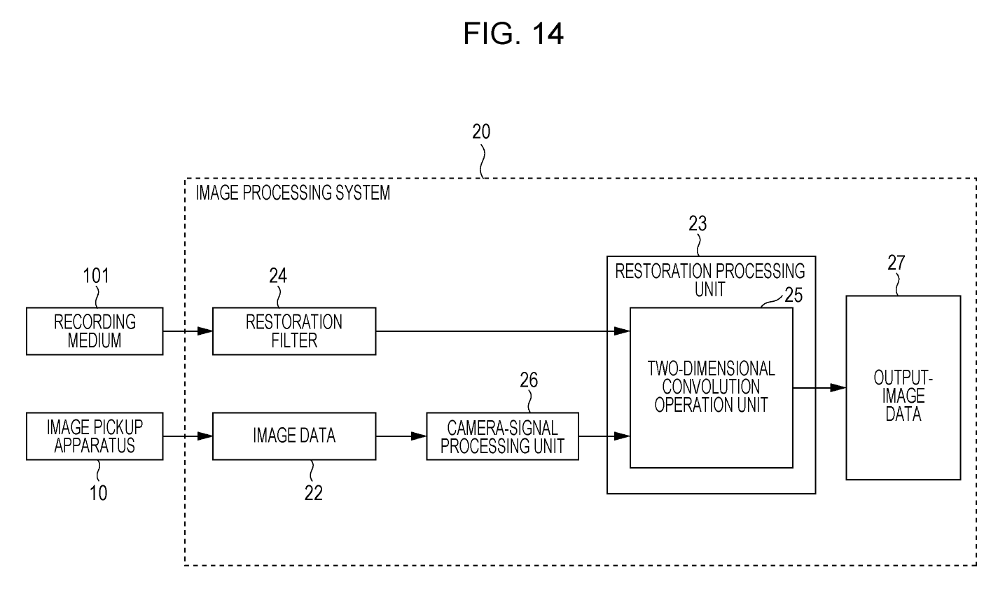

Hereinafter, an image processing system according to an eighth embodiment of the present invention will be described with reference to FIG. 14. The eighth embodiment is different from the first embodiment in that the restoration filter 24 is acquired from the recording medium 101 and the camera-signal processing unit 26 performs the camera-signal processing before the two-dimensional convolution operation.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-286524 filed Dec. 22, 2010 and No. 2011-201820 filed Sep. 15, 2011, which are hereby incorporated by reference herein in their entirety.

What is claimed is:

1. An image processing apparatus comprising:
an image restoration unit configured to acquire classification information indicating classifying variations in optical performance of an image pickup apparatus which picks up image data into a plurality of patterns, and generate restored image data by using a restoration filter generated based on the classification information.

2. The image processing apparatus according to claim 1,
wherein the image data is acquired via an image pickup system, and
wherein the classification information is information provided to specify an optical transfer function or a restoration filter to correct a rotationally asymmetric aberration caused by the image pickup system.

3. The image processing apparatus according to claim 1, further comprising a storage unit configured to store the optical transfer function or the restoration filter.

4. The image processing apparatus according to claim 3, wherein the optical transfer function or the restoration filter is stored as part of the image data.

5. An image processing method comprising the step of acquiring classification information indicating classifying variations in optical performance of an image pickup apparatus which picks up image data into a plurality of patterns, and generating restored image data by using a restoration filter generated based on the classification information.

6. A computer-readable storage medium storing a computer-executable process that causes a computer to execute a method comprising:
acquiring classification information indicating classifying variations in optical performance of an image pickup apparatus which picks up image data into a plurality of patterns; and
generating restored image data by using a restoration filter generated based on the classification information.

7. An image processing system comprising:
the image processing apparatus according to claim 1; and
a display unit configured to display the restored image data generated with the image processing apparatus.
